(19) United States
(12) Patent Application Publication
(10) Pub. No.: US 2023/0109360 A1
(43) Pub. Date: Apr. 6, 2023

(54) ILLUMINATION OPTICAL UNIT AND IMAGE PROJECTION DEVICE USING THE SAME

(71) Applicant: Hitachi-LG Data Storage, Inc., Tokyo (JP)

(72) Inventors: Toshiteru NAKAMURA, Tokyo (JP); Takuma KUNO, Tokyo (JP)

(21) Appl. No.: 17/868,938

(22) Filed: Jul. 20, 2022

(30) Foreign Application Priority Data
Sep. 28, 2021 (JP) 2021-157312

(51) Int. Cl. H04N 9/31; G02B 27/01

(52) U.S. Cl. CPC H04N 9/317; G02B 27/0172; H04N 9/3167; G02B 27/0093

(57) ABSTRACT

Provided is an illumination optical unit configured to illuminate an image display unit configured to display an image. The illumination optical unit includes: a light source configured to emit light; a lens unit configured to convert divergent light from the light source into approximately collimated light; and a light branching unit to which the light emitted from the lens unit is incident, and which branches an optical path into an optical path of illumination light propagating to the image display unit, and an optical path along which light from the image display unit propagates to a projection side. The light branching unit includes two or more emission/reflection planes configured to emit the illumination light.

### CROSS-REFERENCE TO RELATED APPLICATION

The present application claims priority from Japanese application JP 2021-157312, filed on Sep. 28, 2021, the contents of which is hereby incorporated by reference into this application

### BACKGROUND OF THE INVENTION

### 1. Field of the Invention

The present invention relates to an illumination optical unit configured to display an image, and an image projection device including an image display unit that displays an image by using the illumination optical unit.

### 2. Description of the Related Art

An image projection device such as a projector and a head-mounted display (hereinafter, abbreviated as “HMD”) is required to have not only a display performance such as visibility of an image but also a structure excellent in portability and a mounting property in a small size.

As a prior art document in this technical field, JP 2009-265549 A is exemplified. JP 2009-265549 A discloses a projector including: a light source that emits light; a separation unit that allows one light beam having a specific polarization component in the light emitted from the light source to be transmitted therethrough, and reflects other light beams having a polarization component orthogonal to the specific polarization component toward a projection optical system; an image forming unit that is a liquid crystal element using the one light beam, modulates and reflects the one light beam that is incident, and emits the one light beam as projection light; a reflection unit that rotates a polarization direction of the projection light that is incident to the separation unit and is reflected therefrom and emits the projection light toward the projection optical system; and a reflection-type polarization plate that detects the projection light emitted from the reflection unit, reflects the other light beams reflected from the separation unit, and returns the light beams to the light source.

In JP 2009-265549 A, the optical system of the image projection device is constituted by an image generation unit including an illumination unit that transfers light emitted from the light source unit to an image display unit, and a projection unit that projects image light generated by the image display unit. In the illumination unit, various functions for realizing image display with high image quality in a light source unit that emits light to the illumination unit, a color mixing unit that mixes light beams from respective light sources, a luminance uniformizing unit configured to illuminate a small-sized display at uniform luminance, a light branching unit configured to switch an optical path to the projection unit, a unit configured to uniformize luminance, and the like are implemented by independent optical components, respectively. Therefore, there is a problem that the size of the device increases.

That is, JP 2009-265549 A does not consider compatibility between high image quality of a display image and a reduction in size of the optical system in the image projection device, and a problem thereof.

### SUMMARY OF THE INVENTION

An object of the invention is to provide an illumination optical unit that makes a reduction in size of an optical system and high image quality compatible with each other, and an image projection device including an image display unit that displays an image by using the illumination optical unit.

According to an aspect of the invention, there is provided an illumination optical unit that illuminates an image display unit that displays an image. The illumination optical unit includes: a light source configured to emit light; a lens unit configured to convert divergent light from the light source into approximately collimated light; and a light branching unit to which the light emitted from the lens unit is incident, and which branches an optical path into an optical path of illumination light propagating to the image display unit, and an optical path along which light from the image display unit propagates to a projection side. The light branching unit includes two or more emission/reflection planes configured to emit the illumination light.

According to the invention, it is possible to provide an illumination optical unit that makes a reduction in size of an optical system and high image quality compatible with each other, and an image projection device including an image display unit that displays an image by using the illumination optical unit.

### BRIEF DESCRIPTION OF THE DRAWINGS

FIG. 1 is a functional block configuration diagram of an image projection device in Example 1;

FIG. 2 is a block configuration diagram illustrating an example of a hardware configuration of an image projection device as an HMD in Example 1;

FIG. 3A is a block configuration diagram of an image generation unit that is mounted on the HMD in Example 1;

FIG. 3B is a block configuration diagram of the image generation unit that is mounted on a projector in Example 1;

FIG. 4A is a view illustrating a usage aspect of the HMD in Example 1;

FIG. 4B is an enlarged view of the image generation unit in FIG. 4A;

FIG. 5 is a configuration diagram of an image generation unit in the related art;

FIG. 6 is a configuration diagram of the image generation unit in Example 1;

FIG. 7A is a configuration diagram of a modification example of the image generation unit in Example 1;

FIG. 7B is a configuration diagram of a modification example of the image generation unit in Example 1;

FIG. 7C is a configuration diagram of a modification example of the image generation unit in Example 1;

FIG. 7D is a configuration diagram of a modification example of the image generation unit in Example 1;

FIG. 8 is a configuration diagram of an image generation unit on which a transmission type liquid crystal panel is mounted in Example 2;

FIG. 9 is a configuration diagram of the image generation unit on which a DMD panel is mounted in Example 2;

FIG. 10 is a view illustrating a usage example of an HMD in Example 3; and

FIG. 11 is a functional block configuration diagram of the HMD in Example 3.

### DETAILED DESCRIPTION OF THE PREFERRED EMBODIMENTS

Hereinafter, examples of the invention will be described with reference to the accompanying drawings.

### Example 1

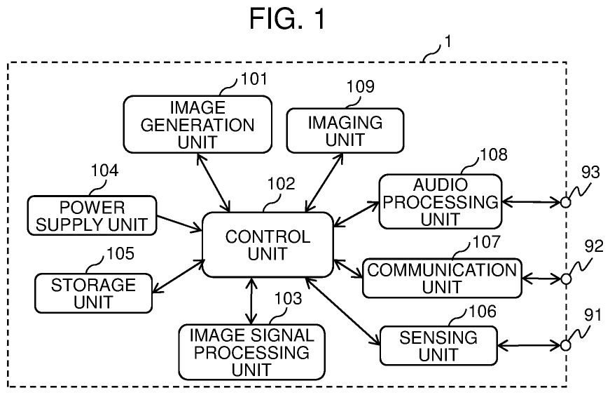

FIG. 1 is a functional block configuration diagram of an image projection device in an example. In FIG. 1, an image projection device 1 is an HMD or a projector, and includes an image generation unit 101, a control unit 102, an image signal processing unit 103, a power supply unit 104, a storage unit 105, a sensing unit 106, a communication unit 107, an audio processing unit 108, an imaging unit 109, and input and output units 91 to 93.

The image generation unit 101 enlarges and projects an image generated by a small-sized display unit to be described later, and displays the image. For example, the image projection device 1 is the HMD, the image generation unit 101 enlarges and projects an image generated in the small-sized display unit as a virtual image, and displays an image of augmented reality (AR) or a mixed reality (MR) to a field of view of a wearer (user).

The control unit 102 collectively controls the entirety of the image projection device 1. A function of the control unit 102 is realized by an operation device such as a CPU. The image signal processing unit 103 supplies an image signal for display to a display unit inside the image generation unit 101. The power supply unit 104 supplies power to respective parts of the image projection device 1.

The storage unit 105 stores information necessary for processing in the respective parts of the image projection device 1 and information generated in the respective parts of the image projection device 1. In addition, in a case where a function of the control unit 102 is realized by the CPU, the storage unit 105 stores a program executed by the CPU and data. For example, the storage unit 105 is constituted by a storage device such as a random access memory (RAM), a flash memory, a hard disk drive (HDD), and a solid state drive (SSD).

The sensing unit 106 is connected to various sensors through the input and output unit 91 that is a connector, and detects posture of the image projection device 1, that is, a posture of a user, a direction of the head of the user, an inclination of the projector, a movement, an ambient temperature, and the like on the basis of a signal detected by the various sensor. As the various sensors, for example, an inclination sensor, an acceleration sensor, a temperature sensor, a sensor of a global positioning system (GPS) that detects position information of the user, and the like are connected.

The communication unit 107 performs communication with an external information processing device by short-range radio communication, long-range radio communication, or wired communication through the input and output unit 92 that is a connector. Specifically, communication is performed by Bluetooth (registered trademark), Wi-Fi (registered trademark), a mobile communication network, a universal serial bus (USB, registered trademark), a high-definition multimedia interface (HDMI (registered trademark)), or the like.

The audio processing unit 108 is connected to an audio input and output device such as a microphone and a speaker through the input and output unit 93 that is a connector, and performs input or output of an audio signal. For example, the imaging unit 109 is a small-sized camera or a small-sized time of flight (TOF) sensor, and images a direction of a field of view of the user of the image projection device 1.

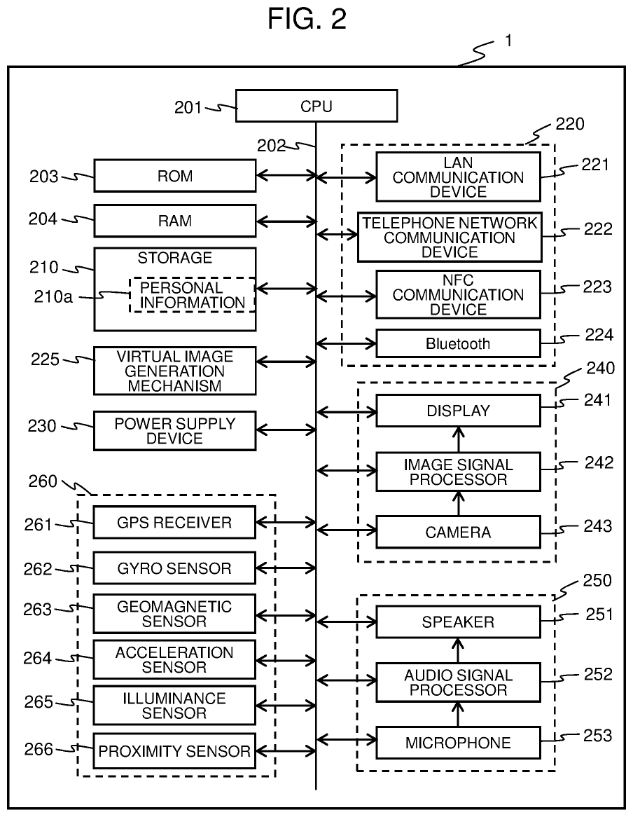

FIG. 2 is a block configuration diagram illustrating an example of a hardware configuration of the image projection device 1 as the HMD. As illustrated in FIG. 2, the image projection device 1 includes a CPU 201, a system bus 202, a read only memory (ROM) 203, a RAM 204, a storage 210, a communication processing device 220, a power supply device 230, a video processor 240, an audio processor 250, and a sensor 260.

The CPU 201 is a microprocessor unit that controls the entirety of the image projection device 1. The CPU 201 corresponds to the control unit 102 in FIG. 1A. The system bus 202 is a data communication path for transmitting and receiving data between the CPU 201 and respective operation blocks in the image projection device 1.

The ROM 203 is a memory that stores a basic operation program such as an operating system, and other operation programs, and for example, a rewritable ROM such as an electrically erasable programmable read-only memory (EEPROM) and a flash ROM can be used.

The RAM 204 becomes a work area when executing the basic operation program and the other operation programs. The ROM 203 and the RAM 204 may be integrated with the CPU 201. In addition, the ROM 203 may not have an independent configuration as illustrated in FIG. 2, and may use a partial storage region in the storage 210.

The storage 210 stores an operation program or an operation setting value of the image projection device 1, personal information 210a of a user who uses the image projection device 1, and the like. Although not particularly exemplified below, the storage 210 may stores an operation program downloaded on a network, or various pieces of data created by the operation program. In addition, a partial storage region of the storage 210 may be substituted with a part or the entirety of a function of the ROM 203. As the storage 210, for example, a device such as a flash ROM, an SSD, and an HDD may be used. The ROM 203, the RAM 204, and the storage 210 correspond to the storage unit 105. Note that, the operation program stored in the ROM 203 or the storage 210 can be updated and functionally expanded by executing a download process from each device on a network.

The communication processing device 220 includes a local area network (LAN) communication device 221, a telephone network communication device 222, a near field communication (NFC) communication device 223, and a BlueTooth communication device 224. The communication processing device 220 corresponds to the communication unit 107 in FIG. 1. FIG. 2 illustrates a case where the LAN communication device 221, the NFC communication device 223, and the BlueTooth communication device 224 are included in the communication processing device 220, but as illustrated in FIG. 1, the devices may be connected as external devices of the image projection device 1 through the input and output unit 92. The LAN communication device 221 is connected to a network through an access point, and transmits and receives data to and from a device on the network. The NFC communication device 223 transmits and receives data through radio communication when a corresponding reader/writer is adjacent thereto. The BlueTooth communication device 224 transmits and receives data to and from an information processing device that is adjacent thereto through radio communication. Note that, the image projection device 1 may include the telephone network communication device 222 that transmits and receives call and data to and from a base station of a mobile telephone communication network.

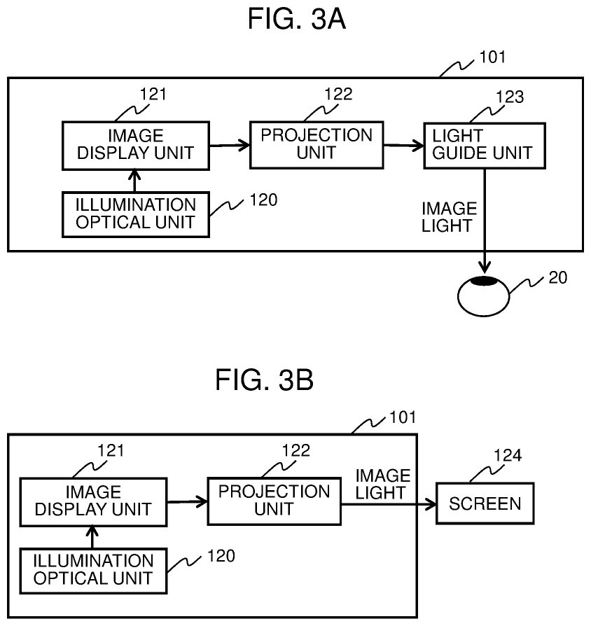

A virtual image generation mechanism 225 corresponds to the image generation unit 101 in FIG. 1. A specific configuration of the virtual image generation mechanism 225 will be described later with reference to FIG. 3A.

The power supply device 230 is a power supply device that supplies power to the image projection device 1 in a predetermined standard. The power supply device 230 corresponds to the power supply unit 104 in FIG. 1. FIG. 2 illustrates a case where the power supply device 230 is included in the image projection device 1, but the power supply device 230 may be connected as an external device of the image projection device 1 through any of the input and output units 91 to 93 and the image projection device 1 may be powered by the external device.

The video processor 240 includes a display 241, an image signal processing processor 242, and a camera 243. The image signal processing processor 242 corresponds to the image signal processing unit 103 in FIG. 1. In addition, the camera 243 corresponds to the imaging unit 109 in FIG. 1, and the display 241 corresponds to a small-sized display unit to be described later. FIG. 2 illustrates a case where the display 241 and the camera 243 are included in the video processor 240, but as illustrated in FIG. 1, these devices may be connected as external devices of the image projection device 1 through an input and output unit (for example, the input and output unit 93).

The display 241 displays image data processed by the image signal processing processor 242.

The image signal processing processor 242 causes the display 241 to display image data that is input. The camera 243 is a camera unit that functions as an imaging device that inputs image data of the periphery or a target by converting light input from a lens into an electric signal by using an electronic device such as a charge coupled device (CCD) and a complementary metal oxide semiconductor (CMOS).

The audio processor 250 includes a speaker 251, an audio signal processor 252, and a microphone 253. The audio processor 250 corresponds to the audio processing unit 108 in FIG. 1. FIG. 2 illustrates a case where the speaker 251 and the microphone 253 are included in the audio processor 250, but as illustrated in FIG. 1, these devices may be connected as external devices of the image projection device 1 through the input and output unit 93.

The speaker 251 outputs an audio signal that is processed by the audio signal processor 252. The audio signal processor 252 outputs input audio data to the speaker 251. The microphone 253 converts audio into audio data and outputs the audio data to the audio signal processor 252.

The sensor 260 is a sensor group for detecting a state of the image projection device 1, and includes a GPS receiver 261, a gyro sensor 262, a geomagnetic sensor 263, an acceleration sensor 264, an illuminance sensor 265, and a proximity sensor 266. The sensor 260 corresponds to the sensing unit 106. FIG. 2 illustrates a case where the sensor 260 includes the GPS receiver 261, a gyro sensor 262, the geomagnetic sensor 263, the acceleration sensor 264, the illuminance sensor 265, and the proximity sensor 266, but as illustrated in FIG. 1, the sensors may be connected as external devices of the image projection device 1 through the input and output unit 91. The respective sensors correspond to a general sensor group that is known in the related art, and thus description thereof will be omitted. In addition, the configuration of the image projection device 1 illustrated in FIG. 2 is illustrative only, and a part of the configuration may not be included.

FIG. 3A is a block configuration diagram of the image generation unit 101 that is mounted on an HMD. The image generation unit 101 includes an illumination optical unit 120, an image display unit 121, a projection unit 122, and a light guide unit 123.

The illumination optical unit 120 irradiates the image display unit 121 that is a small-sized display unit with light transmitted from a light source such as an LED and a laser. The image display unit 121 is an element configured to display an image, and as the element, a liquid crystal display, a digital micromirror device, an organic EL display, a micro LED display, micro electro mechanical systems (MEMS), a fiber scanning device, or the like is used. The projection unit 122 is a device that enlarges image light from the image display unit 121 and projects the image light as a virtual image. The light guide unit 123 is a light guide plate, performs duplication of the image light for enlargement of an eye-box, and transfers the image light transmitted from the projection unit 122 to a user's pupil 20. When the image light imaged on a retina in the pupil 20, the user can visually recognize the image light.

FIG. 3B is a block configuration diagram of the image generation unit 101 that is mounted on a projector. FIG. 3B is different from FIG. 3A in that the light guide unit 123 is not provided, and the image generation unit 101 is constituted by the illumination optical unit 120, the image display unit 121, and the projection unit 122, and the projection unit 122 enlarges image light from the image display unit 121 and projects the image light to an external screen 124.

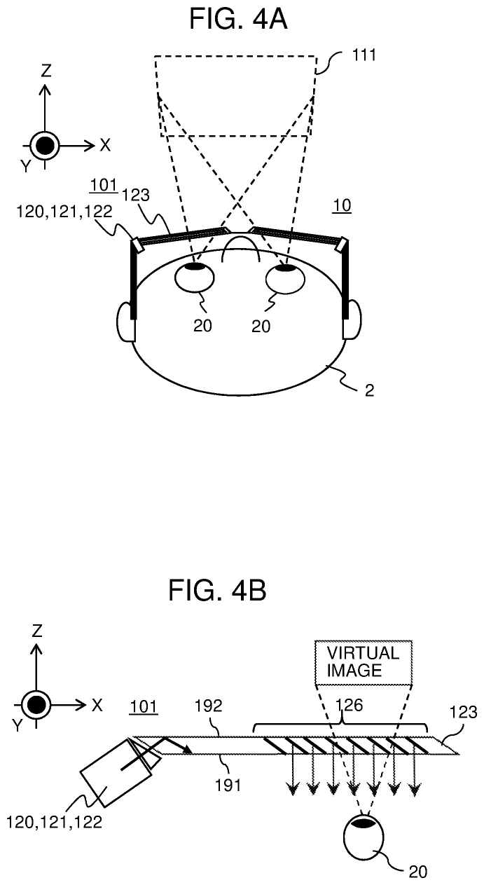

FIG. 4A and FIG. 4B are views illustrating a usage aspect of the HMD 10 in this example. FIG. 4A illustrates a state when viewed from a head direction of the user 2, an X-axis represents a horizontal direction, a Y-axis represents a vertical direction, and a Z-axis represents a visual axis direction that is a line-of-sight direction of the user 2. In the following drawings, the directions of the X-axis, the Y-axis, and the Z-axis are defined in a similar manner. FIG. 4B is an enlarged view of the image generation unit 101 in FIG. 4A.

As illustrated in FIG. 4A, the HMD 10 is mounted on the head of the user 2, and causes an image generated by the illumination optical unit 120, the image display unit 121, and the projection unit 122 to propagate to the user's pupil 20 through the light guide unit 123. At that time, the user 2 can visually recognize an image (virtual image) in a partial image display region 111 within a visual field in a state (see-through type) in which the outside can be visually recognized. Note that, FIG. 4A illustrates a configuration in which the image is displayed in both eyes, but a monocular configuration is also possible. In addition, in the HMD 10, the imaging unit 109 in FIG. 1 can also image a visual field range of the user 2.

The eye-box that is formed by the image generation unit 101 is preferably enlarged in a two-dimensional direction from the viewpoint of visibility of an image. When function implement to the illumination optical unit 120, the image display unit 121, and the projection unit 122 is progressed for high image quality or an improvement of luminance, optical components increase, and a size of a device increases.

As illustrated in FIG. 4A, from the viewpoints of the weight, a mounting property, and a design property of an external appearance from a device characteristic in which the HMD is used in a state of being worn the body, it is important that the HMD can display augmented reality with the same sense of use as in eyeglasses in the related art, and this increases a product value and becomes an important point.

In addition, as illustrated in FIG. 4B, the light guide unit 123 is a light guide plate including two main surfaces 191 and 192 in an approximately parallel flat plate shape, and includes at least two or more emission/reflection planes 126 which are partial reflection planes on an inner side in order to enlarge the eye-box. The light guide unit 123 has a function of causing image light output from the projection unit 122 to propagate through total internal reflection, and duplicating the image light from the projection unit 122 by the emission/reflection planes 126 including a reflection film that reflects a part of the image light. In addition, it is preferable that the emission/reflection planes 126 are parallel to each other so that reflected image light does not have an angular deviation.

The illumination optical unit 120, the image display unit 121, and the projection unit 122 can be disposed on an outer side of the field of view due to the image light transfer function of the light guide unit 123, and the reflectance of the emission/reflection planes 126 is reduced, and thus the see-through property of the periphery and the visibility of an image can be compatible with each other.

For example, in a case of using a spontaneously light-emitting panel such as an organic EL and a micro LED in the image display unit 121, the illumination optical unit 120 is not necessary, and thus a reduction in size of the image generation unit 101 can be expected. However, in the spontaneous light-emitting panel on which minute light-emitting pixels are mounted, there is a limit in a great improvement of light-emitting efficiency, and in the light guide unit 123, the reflectance of the emission/reflection planes 126 cannot be set to be high from the viewpoint of securement of the see-through property, and thus a trade-off relationship occurs in usage efficiency of the image light.

High-luminance image output is required for the image generation unit on which the light guide unit 123 is mounted, and thus in a case where the image display unit 121 is set as the spontaneous light-emitting panel, there is a problem that a current device performance is significantly deficient in image luminance capable of being visually recognized outdoors. Even in the projector, in a case where the spontaneous light-emitting panel is used in the image display unit 121, the illumination optical unit 120 is not necessary, and thus a reduction in size of the image generation unit 101 can be expected. In the projector that enlarges and projects an image onto a screen, a high optical output is also required for the image display unit. However, in the spontaneous light-emitting panel on which minute light-emitting pixels are mounted, there is a limit in a great improvement of light-emitting efficiency, and in a case where the image display unit 121 is set as the spontaneous light-emitting panel, there is a problem that sufficient image luminance is not obtained in the current device performance.

As described above, in the projector or the HMD, there is a problem in compatibility between a reduction in size of an illumination system and high luminance. Hereinafter, a solution to the problem will be described.

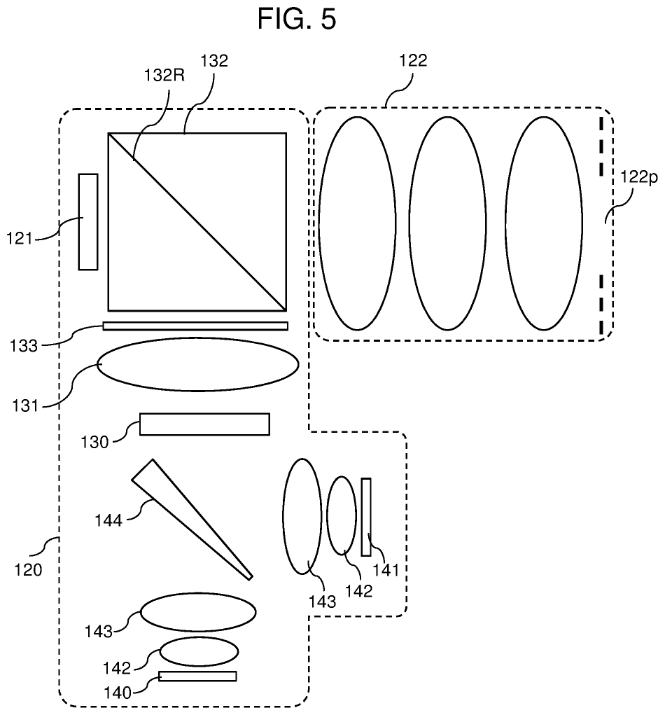

FIG. 5 is a configuration diagram of an image generation unit in the related art. The image generation unit includes an illumination optical unit 120, an image display unit 121, and a projection unit 122. The illumination optical unit 120 irradiates the image display unit 121 with light transmitted from a light source such as an LED and a laser. The image display unit 121 is a micro display configured to display an image, and a liquid crystal display, a digital micro mirror device, or the like is used as the micro display. The projection unit 122 enlarges image light from the image display unit 121 and projects the enlarge image light as a virtual image.

The illumination optical unit 120 includes a light source 140 of green (G), and a light source 141 of red (R) and blue (B) as a light source unit. Light transmitted from each of the light sources is approximately collimated by condensing lenses 142 and 143. The approximately collimated light from each color light source is combined by a color combination unit 144. FIG. 5 illustrates an example in which a wedge-shaped dichroic mirror is used as the color combination unit 144. The dichroic mirror combines approximately collimated light beams of R-light, B-light, and G-light and emits the resultant light. At this time, it is not necessary for optical axes of respective colors to completely aligned, and the optical axes may be slightly shifted so that intensity distributions approximately match each other on a predetermined plane.

The color-combined light is incident to a microlens array 130 that becomes a virtual secondary light source. The microlens array 130 is illuminated by an approximately collimated luminous flux emitted from the color combination unit 144. When using the microlens array 130 as a luminance uniformizing unit, light can be condensed to only a predetermined range of a micro display of the image display unit 121. In addition, there is an advantage that a luminance distribution of illumination light on the image display unit 121 is uniformized and high image quality is obtained.

A condensation lens 131 as a condensing optical member images a cell image of the microlens array 130 on the image display unit 121.

In a case where a liquid crystal on silicon (LCOS, registered trademark) or the like is used in the image display unit 121, an outgoing path facing the image display unit 121, and a light branching unit 132 configured to guide light transmitted from the image display unit 121 toward a projection optical path on a projection unit side are provided. The light branching unit 132 divides optical paths to the illumination optical unit 120 and the projection unit 122 from each other. The projection unit 122 projects an image of the image display unit 121 as infinity or a virtual image. The image light from the projection unit 122 is incident to the light guide unit 123, and a user can visually recognize the image in a state in which the see-through property is secured.

In a case of visually recognizing an image in the optical system, a conjugate image of the light sources 140 and 141 which is duplicated by the microlens array 130 is formed on an emission plane of the microlens array 130. In addition, the emission plane of the microlens array 130 and an exit pupil of the projection unit 122 have an approximately conjugate positional relationship. Accordingly, the conjugate image of the light sources 140 and 141 which is formed on the emission plane of the microlens array 130 and a conjugate image of a microlens cell emission plane of the microlens array 130 are formed at an exit pupil position 122p of the projection unit 122. Accordingly, when a user views an image through a light guide plate, the conjugate image of the microlens cell and the conjugate image of the light source appear to be superimposed on each other in front of the image, and thus visibility of the image deteriorates.

Note that, since the light guide plate has a function of duplicating the exit pupil of the projection unit 122 to enlarge the eye-box, in a case of the number of duplication times is large, the conjugate images may be repeatedly superimposed on each other, and may be inconspicuous. On the other hand, in a case of using a beam splitter mirror array type light guide plate, the number of times of duplication is reduced in principle in comparison to other methods, and visibility of an image greatly deteriorates due to the conjugate images.

Therefore, as a configuration of suppressing visibility of the conjugate images of the microlens cell and the light sources, a diffusion plate 133 is provided in the vicinity of the condensation lens 131 of the illumination optical unit 120 as a luminance uniformizing unit configured to diffuse light transmitted from the microlens array 130 and uniformize luminance. When the diffusion plate 133 is provided, the conjugate images of the microlens cell and the light sources may not be blurred and inconspicuous. At this time, when the diffusion plate 133 is disposed in front of the image display unit 121, it is possible to prevent the resolution of an enlarge image (virtual image) of the image display unit 121 from being influenced by the projection unit 122. As described above, in the HMD 10 using the light guide plate, there is a problem relating to occurrence of the conjugate image, and this problem can be suppressed by providing the diffusion plate 133.

As described above, in the illumination optical unit 120 in the image generation unit in the related art, since various functions such as a function of collimating light transmitted from a light source with a lens, a function of mixing collimated light transmitted from respective light sources with a dichroic mirror, a function of uniformizing a luminance distribution by a microlens array and a condensation lens, and a function of branching an optical path with polarization are implemented by independent optical components, respectively, there is a problem that a size becomes large.

Therefore, when an optical component having a plurality of functions of the illumination optical unit 120 can be provided, it is possible to realize a reduction in size.

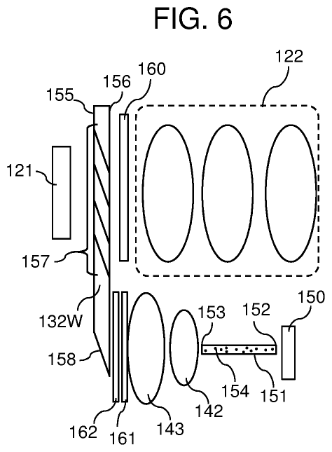

FIG. 6 illustrates a configuration of the image generation unit 101 in this example. FIG. 5 illustrates light sources in which the light source 140 emits green light, the light source 141 emits red light and blue light, and two colors of light sources are mounted in the same package, but a light source 150 in FIG. 6 shows an example in which three colors of light sources are integrated in the same package. That is, the light source 150 is a multi-chip light source in which a red chip, a green chip, and a blue chip configured to emit light beams in wavelength ranges of red, green, and blue are mounted in one casing.

In addition, in FIG. 6, a small-sized light integrator 151 configured to enhance a color mixture property and uniformity is mounted to reduce a size of the illumination optical unit. The light integrator 151 has shape similar to a quadrangular column or a circular column, and the inside is filled with medium A having predetermined high transparency. In addition, the light integrator 151 includes an incident plane 152, an emission plane 153, and a side surface. The incident plane 152 and the emission plane 153 are planes to which light is incident and from which the light is emitted. According to Snell's law, it is known that a light beam larger than a threshold angle cannot proceed from a medium with a high refractive index to a medium with a low refractive index, and is subjected to total internal reflection (hereinafter, referred to as “TIR”). Accordingly, the side plane of the light integrator 151 is a plane having a function of confining light incident from the incident plane 152 with TIR.

Since light emitted from the light integrator 151 becomes divergent light, the light is converted into approximately collimated light by condensing lenses 142 and 143. When using the light integrator 151, it is possible to provide the illumination optical unit 120 of the image generation unit 101 in which light can be diffused while being confined, and light beams from the multi-chip light source can be efficiently mixed and uniformized within a limited space, and a size is small and efficiency is high.

Note that, the inside of the light integrator 151 may be randomly filled with scattering particles 154 filled with a highly transparent medium B having a refractive index different from that of the medium A. According to Snell's law, when passing through a medium having a different refractive index, a light beam is emitted at an angle different from an incident angle. The scattering particles 154 have a function of scattering a light beam wile changing an angle of the light beam that is proceeding with the above-described principle. The scattering particles may have a spherical shape or other shapes. When the scattering particles are contained, color mixture or uniformity of light can be effectively realized even in a light integrator having a shorter length.

Light emitted from the condensing lenses 142 and 143 is incident to a light guide plate type light branching unit 132W. The light branching unit 132W includes a set of main surfaces 155 and 156 that have an approximately parallel flat shape and confine illumination light with total internal reflection that becomes internal reflection, and has an emission/reflection plane group 157 including two or more emission/reflection planes configured to emit illumination light to the outside of the light branching unit on an inner side. In addition, an incident/reflection plane 158 configured to reflect the illumination light to the inside of the light branching unit 132W may also be provided.

FIG. 6 illustrates a case where the internal reflection is total internal reflection by two parallel planes. However, the internal reflection may not be the total internal reflection. For example, a light guide plate having a parallel plane that causes normal reflection or diffusion reflection to occur may be used. This light guide plate is obtained by attaching a light-transmitting or light-reflecting film to a part or the entirety of the parallel planes of the light guide plate that constitutes the parallel planes.

It is necessary for the light branching unit 132W to transfer an image to an illumination or projection side without omission in an effective region of the image display unit 121. Therefore, it is necessary for the light branching unit 132 in the related art to be provided with the reflection plane 132R having a size larger than the effective region of the image display unit 121 as illustrated in FIG. 5, and thus the size becomes large. In the light branching unit 132W in this example, when an interval of adjacent emission/reflection planes of the emission/reflection plane group 157 is set as L1, and in an effective region of the image display unit 121, a length of a side in an arrangement direction of the emission/reflection planes is set as LA, LA is set to be longer than L1, and a plurality of emission/reflection planes having an interval smaller than the effective region of the image display unit 121 are arranged. According to this, it is possible to reduce the thickness per one emission/reflection plane, and thus the thickness of the light branching unit 132W is reduced as a whole.

In addition, a screen aspect ratio of a display image is typically 16:9 or 4:3 rather than 1:1 in which a length in the vertical direction and a length in the horizontal direction are the same as each other. Accordingly, an effective region of the image display unit 121 also has an aspect ratio, and when a short-side direction of the effective region is set to be approximately parallel to the arrangement direction of the emission/reflection planes in the emission/reflection plane group 157 of the light branching unit 132W, a necessary number of emission/reflection planes arranged can be reduced, and thus the cost can be reduced.

For example, in a case where a liquid crystal micro display is used in the image display unit 121, ON and OFF of pixels are switched by rotating a polarization direction of illumination light in each pixel of the micro display. Accordingly, in the light branching unit 132W, a reflection film formed on the emission/reflection planes of the emission/reflection plane group 157 a preferably set as a polarizing reflection film.

For example, a case where S-polarization illumination light is reflected from the emission/reflection plane group 157 to illuminate the image display unit 121 will be considered. In a case where the image display unit 121 is a micro display using a liquid crystal, in a pixel that is turned ON, a polarization direction is rotated, for example, by 90°, and P-polarized light is incident to the emission/reflection plane group 157 from the image display unit 121. Since the emission/reflection plane group 157 has a polarization property, the P-polarized light is transmitted therethrough, is guided to the projection unit 122, and is projected to a pixel that is turned ON through the projection unit 122. Accordingly, a user visually recognizes the pixel that is turned ON.

Here, in a case where the emission/reflection plane group 157 is set as a typical polarization beam splitter to have a reflection characteristic in which S-polarized light is reflected approximately by 100%, and P-polarized light is transmitted approximately by 100%, the entirety of light is reflected from an emission/reflection plane closest to an incident part to the light branching unit 132W in the emission/reflection plane group 157, and it is difficult to illuminate the entirety of an effective region of the image display unit 121. Therefore, in this case, the emission/reflection plane group 157 is set as a group of partial reflection planes which reflects a part of S-polarized light and allows a part of S-polarized light and a part of P-polarized light to be transmitted therethrough, and the partial reflection planes are arranged in an array shape.

In addition, the emission/reflection plane group 157 of the light branching unit 132W in this example includes two or more emission/reflection planes, and thus light propagating through the inside of an element is gradually reflected whenever passing through each of the emission/reflection planes, and propagates through the inside while reducing the quantity of light. Accordingly, the reflectance of the emission/reflection plane group 157 is assumed to be the same in each plane, the quantity of light that illuminates the image display unit 121 becomes uneven in the region. Therefore, as an example, when employing a configuration in which the reflectance of the emission/reflection planes of the emission/reflection plane group 157 are set to be higher as being farther from the incident part to the light branching unit 132W, uniformity of the illumination light can be improved. In addition, in a case where the emission/reflection plane group 157 is a reflection film having a polarization property, with regard to the reflectance of the emission/reflection planes, when employing a configuration in which a reflectance of S-polarized light is set to be higher as being farther from the incident part to the light branching unit 132W, uniformity of the illumination light can be improved. Accordingly, with regard to the viewpoint of light usage efficiency, it is preferable that the reflectance of the S-polarized light in the emission/reflection plane farther from the incident part to the light branching unit 132W is set to approximately 100% from the viewpoint of light usage efficiency.

When the reflectance of the partial reflection planes of the emission/reflection plane group 157 is set to be low, luminance uniformity of the illumination light inside the effective region of the image display unit 121 is improved, but the light usage efficiency deteriorates. On the other hand, when the reflectance is raised, the light usage efficiency is improved, but the luminance uniformity of the illumination light deteriorates as described above. Accordingly, from the viewpoints of the light usage efficiency and the luminance uniformity, it is preferable that the reflectance of the S-polarized light of the partial reflection planes of the emission/reflection plane group 157 is set to 5% to 60%.

On the other hand, when the reflectance of the emission/reflection plane group 157 is suppressed to be low, even when the reflectance is the same in each plane, that is, even when the same reflection film is used for the partial reflection planes, large luminance unevenness is not caused to occur. Rather, the respective partial reflection planes can be formed at the same film formation process, a reduction in manufacturing cost is realized. Note that, from the viewpoint of securement of both the luminance uniformity and the see-through property, it is preferable that the reflectance of the emission/reflection plane group 157 is set to be 10% or less.

In addition, when the image display unit 121 and the light branching unit 132W are arranged at positions close to the projection unit 122, a boundary portion of the emission/reflection planes of the emission/reflection plane group 157 of the light branching unit 132W may also be visually recognized in an image projected from the projection unit 122. Therefore, in consideration of the depth of focus of the projection lens, a predetermined interval is required between the image display unit 121 and the light branching unit 132W. According to an examination that has been made, when considering the depth of focus of a projection unit that is used in a typical small-sized projector or HMD, it is preferable that an interval of 1 mm or greater exists between the main surface 155 on a display unit side in the light branching unit 132W and the image display unit 121.

In addition, it is preferable that the emission/reflection planes of the emission/reflection plane group 157 of the light branching unit 132W are parallel to each other from the viewpoint of manufacturability. That is, it is preferable that the partial reflection planes (emission/reflection planes) of the emission/reflection plane group 157 are parallel to each other. The reason for this is as follows. When a plurality of parallel flat plates on which the partial reflection planes are formed are laminated and bonded integrally, and the resultant laminated body is cut into a predetermined shape, from the incident plane to the emission/reflection planes can be collectively processed, and the light branching unit 132W constituted by a plurality of sheets can be cut. Accordingly, when the partial reflection planes (emission/reflection planes) of the emission/reflection plane group 157 of the light branching unit 132W are set to be parallel to each other, there is an advantage that a manufacturing process can be simplified, and the manufacturing cost can be reduced.

In the emission/reflection plane group 157 of the light branching unit 132W, when overlapping exists between adjacent emission/reflection planes, the luminance of an overlapped portion becomes high, and thus luminance uniformity of the illumination light deteriorates. On the other hand, in a case where an interval exists between adjacent emission/reflection planes, luminance of an interval portion decreases, and thus the luminance uniformity deteriorates. Accordingly, when the thickness of the light branching unit 132W is set to t, and an angle of the emission/reflection planes is set to θ, in a case where the interval L1 of the emission/reflection planes, the thickness t, and the angle θ is set to satisfy a relationship of t/tan θ=L1, the luminance uniformity can be improved.

As described above, the light branching unit 132 without the total internal reflection confinement function in the related art has a problem that an external size increases to prevent occurrence of stray light on a side surface. However, since the light branching unit 132W of this example performs confinement of the image light through the total internal reflection, there is an advantage that illumination light and projection light can be branched while reducing an element size.

Next, a method of improving contrast in this example will be described. As described above, for example, a case where the illumination light that is S-polarized light is reflected from the emission/reflection plane group 157 to illuminate the image display unit 121 will be considered. In a case where the image display unit 121 is the micro display using a liquid crystal, in a pixel that is turned ON, a polarization direction is rotated, and P-polarized light is incident to the emission/reflection plane group 157 from the image display unit 121. Since the emission/reflection plane group 157 has polarization property, the P-polarized light is transmitted therethrough, is guided to the projection unit 122, and is projected to the pixel that is turned ON through the projection unit 122. Accordingly, a user visually recognizes the pixel that is turned ON. On the other hand, in a case of OFF, the polarization direction does not vary, and thus the S-polarized light returns to the emission/reflection plane group 157 from the image display unit 121. At this time, OFF light is S-polarized light and the emission/reflection plane group 157 has a reflectance characteristic that reflects a partial quantity of light of the S-polarized light, but a characteristic of reflecting approximately 100% as described above is not obtained. Accordingly, there is a problem that OFF of the S-polarized light is transmitted through the emission/reflection plane group 157 and is also visually recognized to a user through the projection unit 122. A pixel that should be displayed as black without the quantity of light has the quantity of light, and is apt to project a so-called black floating image with low contrast.

Therefore, a polarization filter 160 that absorbs or reflects light polarized in a predetermined direction may be disposed between the light branching unit 132W and the projection unit 122 for an improvement in contrast. For example, when only the S-polarized light corresponding to the above-described OFF light is absorbed by the polarization filter, it is possible to greatly improve contrast of a projection image. In addition, although not illustrated in the drawing, the polarization filter 160 may be disposed at an arbitrary position as long as the position is on a projection unit 122 side from the light branching unit 132W, or may be disposed on an emission side of the projection unit 122 or within the projection unit 122.

In the configuration illustrated in FIG. 6, since light emitted from the light integrator 151 becomes divergent light, the light is converted into approximately collimated light by condensing lenses 142 and 143. Due to a relationship between the condensing lenses 142 and 143, and the projection unit 122, a conjugate image of the emission plane 153 of the light integrator 151 occurs at the exit pupil position 122p of the projection unit 122 that is in an approximately conjugate positional relationship. Accordingly, when a user views an image through the light guide plate, the conjugate image of the emission plane 153 of the light integrator 151 appears to be superimposed in front of the image, and thus visibility of the image deteriorates.

In addition, as described above, the light guide plate has a function of duplicating the exit pupil of the projection unit 122 to enlarge the eye-box. Accordingly, in a case of using the beam splitter mirror array type light guide plate, the conjugate image is duplicated in the light guide plate, and thus visibility of an image greatly deteriorates.

Therefore, a diffusion plate 161 is provided between the condensing lenses 142 and 143, and the light branching unit 132W as a luminance uniformizing unit. Light is diffused by the diffusion plate 161 and the contour of the conjugate image of the emission plane 153 of the light integrator 151 is blurred. Accordingly, visibility of the conjugate image is reduced, and thus high image quality is obtained. On the other hand, since the diffusion plate 161 has not influence on a projection side, resolution of an output image does not deteriorate.

In addition, inexpensive LED element is used in a light source unit in many cases, and this case, output light becomes non-polarized light. As described above, division of polarized light is important to improve contrast, and only S-polarized illumination light is incident to the emission/reflection plane group 157, and thus efficiency as the entirety of the optical system can be improved. For example, when the polarization filter 162 is mounted at the same position as in the above-described diffusion plate 161, a polarization direction of the illumination light incident to the light branching unit 132W is aligned in a predetermined direction, and thus contrast of a display image can be improved.

The diffusion plate 161 has an operation of disturbing the polarization direction of the illumination light through scattering, and thus when the polarization filter 162 on an illumination side is disposed after the illumination light is transmitted through the diffusion plate 161, uniformity of polarization is raised, and thus a contrast improving effect is obtained. Accordingly, it is preferable that the polarization filter 162 is disposed between the light branching unit 132W and the diffusion plate 161.

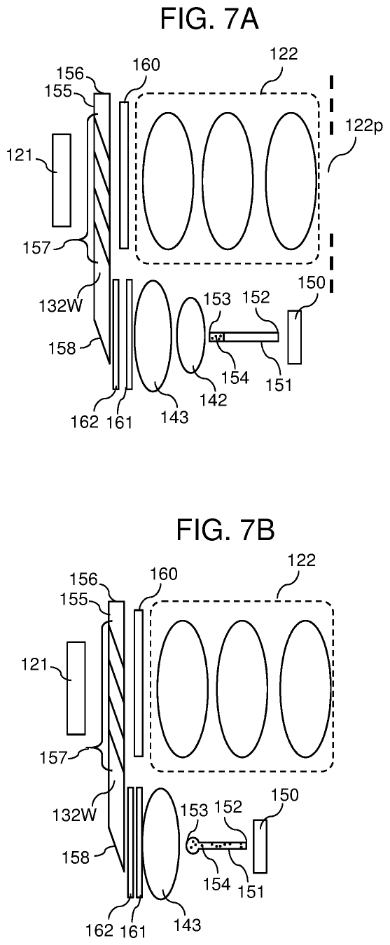

FIGS. 7A to 7D are modification examples of the image generation unit 101 provided with the light branching unit 132W in this example. FIG. 7A is different from FIG. 6 in the configuration of the light integrator 151. In FIG. 7A, the light integrator 151 a transparent layer that is a transparent optical medium that does not contain scattering particles, and a scattering layer containing the scattering particles 154 are integrated with each other. Incident light transmitted from the light source 150 is scattered within the light integrator 151, but scattering occurs not only on forward side but also on a backward side. Therefore, when scattering particles exist in a region close to the incident plane 152, a lot of light beams which return to a direction of a light-emitting unit occur due to backward scattering, and thus light usage efficiency deteriorates. Therefore, when the incident plane 152 side is set as a transparent layer that is a transparent optical medium that does not contain the scattering particles, and color mixing occurs by total internal reflection of an inner plane, and the scattering particles are provided on the emission plane side to greatly perform diffusion (color mixing) immediately before emission, it is possible to provide the light integrator 151 in which light usage efficiency and a reduction in size are compatible with each other.

FIG. 7B illustrates a modification example in which a shape of the emission plane 153 of the light integrator 151 in FIG. 6 has a convex shape. In the configuration illustrated in FIG. 6, light emitted from the light integrator 151 becomes divergent light, and thus the light is converted into approximately collimated light by the condensing lenses 142 and 143, but it necessary to align two sheets of convex lenses to obtain sufficiently collimated light, and thus the size increases. Therefore, as illustrated in FIG. 7B, when the emission plane of the light integrator 151 is set to the convex shape, one sheet of collimate lens and the light integrator are integrated to suppress the degree of divergence of emitted light. Here, one sheet of condensing lens is provided, and thus the size of the device can be reduced.

FIG. 7C is a configuration diagram illustrating a modification example of the light branching unit 132W in FIG. 6. In FIG. 6, the light branching unit 132W inputs light into an element by using the incident/reflection plane 158. Accordingly, it is preferable that an input beam diameter and an incident/reflection plane size are the same magnitude as each other from the viewpoint of light usage efficiency.

However, when enlarging the reflection plane size of the incident/reflection plane 158, a total thickness of the light branching unit 132W increases, and thus there is a problem that it is difficult to secure a sufficient reflection plane size. Therefore, the light branching unit 132W in FIG. 7C has a configuration in which the incident/reflection plane 158 is not used, and illumination light emitted from the condensing lens 143 is input after being transmitted through the main surface 156 of the light branching unit 132W through an optical path correction prism 163. The illumination light input into the light branching unit 132W is reflected by the other main surface 155, and can be confined within the light branching unit 132W. The main surface 155 has a sufficient size, and thus there is an advantage that the thickness of the light branching unit 132W can be reduced while reducing loss at the time of coupling to the light branching unit 132W.

Hereinbefore, description has been given of a configuration using the emission/reflection plane group in the light branching unit 132W, but the function of the emission/reflection plane group 157 may be realized by another method. For example, a polarizing diffraction grating or a polarizing volume hologram may be used. The diffraction grating or the volume hologram is formed, and a part of illumination light propagated through the inside of an element is deflected to the image display unit 121 for illumination.

FIG. 7D is a configuration diagram illustrating a modification example of the image generation unit 101. In a case of using a monochromatic light source or in a case of where LEDs or laser light-emitting units in respective colors such as red, green, and blue, which are mounted on the light source unit, are small and are closely disposed, even when the light integrator in FIG. 6 is not used, color mixing in the total internal reflection within the light branching unit 132W is possible. Accordingly, as illustrated in FIG. 7D, when employing a configuration in which light generated from the light source 150 is made into approximately collimated light by the condensing lenses 142 and 143 and is incident to the light branching unit 132W, it is possible to reduce a size of the device.

In the configuration illustrated in FIG. 7D, due to a relationship between the light source 150, the condensing lenses 142 and 143, and the projection unit 122, conjugate image of the light source 150 occurs in the exit pupil position 122p of the projection unit 122 that is in an approximately conjugate positional relationship. Accordingly, when a user views an image through the light guide plate, the conjugate image of the light source 150 appears to be superimposed in front of the image, and thus visibility of the image deteriorates.

In addition, as described above, the light guide plate has a function of duplicating the exit pupil of the projection unit 122 to enlarge the eye-box. Accordingly, particularly, in a case of using the beam splitter mirror array type light guide plate, the conjugate image is duplicated in the light guide plate, and thus visibility of an image greatly deteriorates.

Therefore, in a similar manner as described above, the diffusion plate 161 is provided between the condensing lenses 142 and 143, and the light branching unit 132W as a luminance uniformizing unit. Light is diffused by the diffusion plate and the contour of the conjugate image of the emission plane 153 of the light integrator 151 is blurred. Accordingly, visibility of the conjugate image is reduced, and thus high image quality is obtained. On the other hand, since the diffusion plate 161 has not influence on a projection side, resolution of an output image does not deteriorate. In addition, as described above, the polarization filter 162 may be disposed between the light branching unit 132W and the diffusion plate 161.

As described above, according to the configuration illustrated in this example, it is possible to provide an illumination optical unit that makes a reduction in size of an optical system and high image quality compatible with each other, and an image projection device including an image display unit that displays an image by using the illumination optical unit.

### Example 2

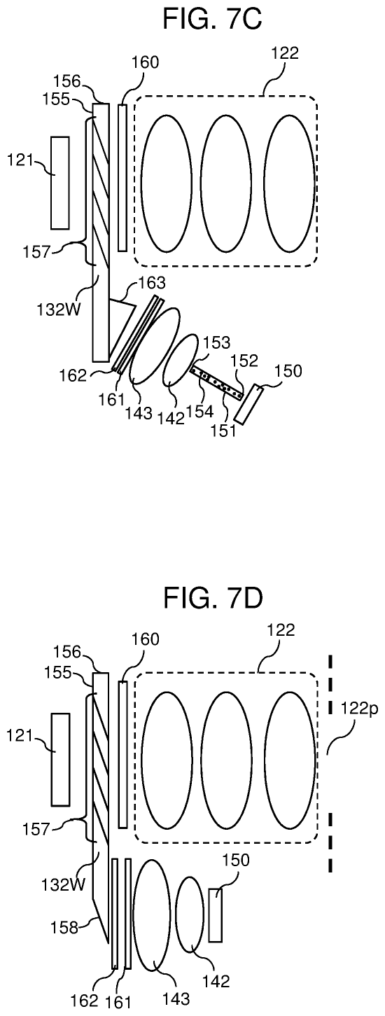

FIG. 8 is a schematic configuration diagram of the image generation unit 101 in a case where a transmission type liquid crystal panel is used in the image display unit 121 in this example. Light from the light source 150 in the image generation unit 101 is color-mixed and uniformized by the light integrator 151, and becomes approximately collimated light by the condensing lenses 142 and 143. In a case where the transmission type liquid crystal panel is used in the image display unit 121, it is not necessary to mount a light branching unit, and the image display unit 121 is illuminated with light that is approximately collimated by the condensing lenses 142 and 143. In light transmitted through the image display unit 121, a polarization direction thereof is converted only in a pixel to be turned ON, is transmitted through the polarization filter 160 mounted in accordance with the image display unit 121, and is projected as an image through the projection unit 122.

Even in the configuration of the image generation unit 101 in this example, due to the relationship between the condensing lenses 142 and 143, and the projection unit 122, a conjugate image of the emission plane 153 of the light integrator 151 occurs at the exit pupil position 122p of the projection unit 122 that is in an approximately conjugate positional relationship. Accordingly, in a case of applying this optical system to the HMD, on a user side, the conjugate image of the emission plane 153 of the light integrator 151 appears to be superimposed in front of a virtual image of the image display unit 121, and thus visibility of the image deteriorates. In addition, as described above, in a case of the HMD using the light guide plate, the light guide plate has a function of duplicating the exit pupil of the projection unit 122 to enlarge the eye-box. Accordingly, particularly, in a case of using the beam splitter mirror array type light guide plate, the conjugate image is duplicated in the light guide plate, and thus visibility of an image greatly deteriorates.

Therefore, the diffusion plate 161 is disposed as a luminance uniformizing unit configured to decrease visibility by blurring only the conjugate image without affecting resolution of an image. When the diffusion plate 161 is disposed at a position as far as possible from the emission plane 153 of the light integrator 151, there is an advantage that the effect of reducing the visibility of the conjugate image by a diffusion plate with a small diffusion angle is obtained, high image quality is realized, and deterioration of light usage efficiency can be suppressed due to the small diffusion angle. Therefore, light usage efficiency and an improvement of visibility can be compatible with each other when disposing the diffusion plate 161 between the condensing lens 143 and the image display unit 121.

In addition, in order to improve contrast, the polarization filter 162 that allows light to be transmitted in a predetermined polarization direction may be disposed on an illumination side, or the polarization filter 162 may be disposed behind the diffusion plate 161 because polarization is disturbed by the diffusion plate 161. According to this, a contrast improving effect is obtained.

Similarly, when the polarization filter 160 that allows light to be transmitted only in a predetermined polarization direction is disposed between the image display unit 121 and the projection unit 122, contrast of an image that is projected by the projection unit 122 can be improved.

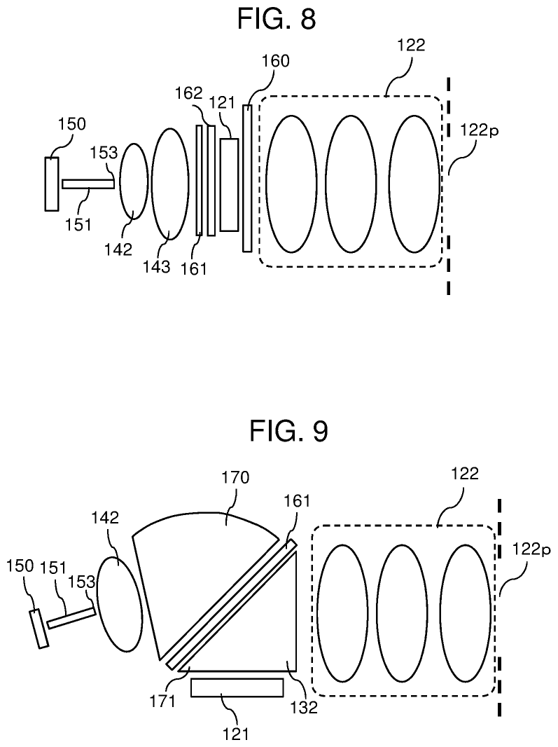

FIG. 9 is a schematic configuration diagram of the image generation unit 101 in a case where digital micromirror device (DMD) panel is used in the image display unit 121. Light emitted from the light source 150 inside the image generation unit 101 is color-mixed and uniformized by the light integrator 151. In the DMD panel that expresses ON/OFF of a pixel by changing a reflection angle of light according to an angle of a mirror, it is necessary for illumination light to be obliquely incident to the panel. At this time, a prism that performs aberration correction due to the oblique incidence is necessary for the illumination optical system. Accordingly, a lens system that collimates light from the light integrator 151 and the aberration correction prism are necessary, and thus a size increases. Therefore, in FIG. 9, the condensing lens 142, and a concave plane composite prism 170 in which a rear-stage condensing lens and the aberration correction prism are integrated are provided. The image display unit 121 is illuminated with illumination light of which aberration due to collimation of light and oblique incidence is corrected by the condensing lens 142 and the concave plane composite prism 170 through the light branching unit 132.

In the DMD panel that expresses ON/OFF of a pixel by changing a reflection angle of light in accordance with an angle of a mirror, a light beam angle of light relating to ON is converted and becomes an angle of total internal reflection with a reflection plane 171 of the light branching unit 132, and the light is output from the DMD panel. Image light subjected to the total internal reflection with the reflection plane 171 of the light branching unit 132 is projected as an image through the projection unit 122.

Even in the configuration of the image generation unit 101 using the DMD panel, due to a relationship between the condensing lens 142, the concave plane composite prism 170, and the projection unit 122, a conjugate image of the emission plane 153 of the light integrator 151 occurs at the exit pupil position 122p of the projection unit 122 that is in an approximately conjugate positional relationship. Accordingly, in a case of applying this optical system to the HMD, on a user side, the conjugate image of the emission plane 153 of the light integrator 151 appears to be superimposed in front of a virtual image of the image display unit 121, and thus visibility of the image deteriorates. In addition, as described above, in a case of the HMD using the light guide plate, the light guide plate has a function of duplicating the exit pupil of the projection unit 122 to enlarge the eye-box. Accordingly, particularly, in a case of using the beam splitter mirror array type light guide plate, the conjugate image is duplicated in the light guide plate, and thus visibility of an image greatly deteriorates.

Therefore, the diffusion plate 161 is disposed as a luminance uniformizing unit configured to decrease visibility by blurring only the conjugate image without affecting resolution of an image. When the diffusion plate 161 is disposed at a position as far as possible from the emission plane 153 of the light integrator 151, there is an advantage that the effect of reducing the visibility of the conjugate image by a diffusion plate with a small diffusion angle is obtained, high image quality is realized, and deterioration of light usage efficiency can be suppressed due to the small diffusion angle. Therefore, the light usage efficiency and the improvement of the visibility can be compatible with each other when disposing the diffusion plate 161 between the concave plane composite prism 170 and the light branching unit 132.

As described above, in a small-sized illumination optical system using the light integrator according to the configuration illustrated in this example, an HMD in which the light usage efficiency and the visibility are compatible with each other can be provided.

### Example 3

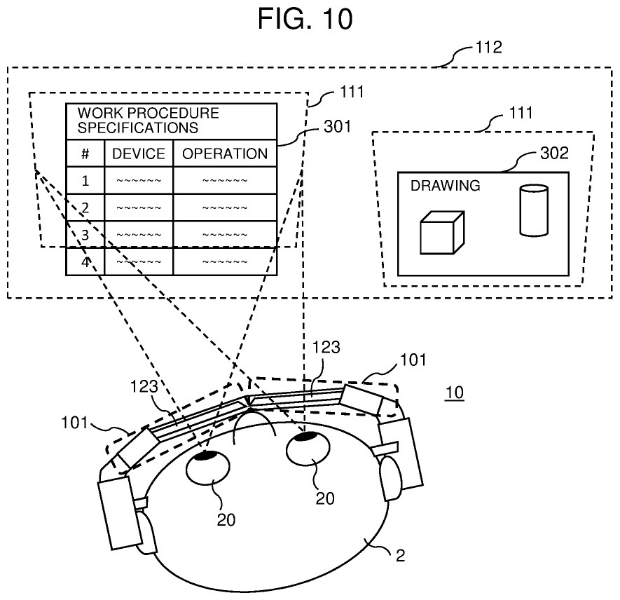

In this example, description will be given of an application example of the HMD on which the image generation unit 101 described in Examples 1 and 2 is mounted. FIG. 10 is a view illustrating a usage example of the HMD in this example. In FIG. 10, the same reference numeral will be given to the same configuration as in FIG. 4A, and description thereof will be omitted.

In FIG. 10, within a field of view of a user 2, contents are displayed in an image (virtual image) display region 111 from the HMD 10. For example, a work procedure specification 301 or a drawing 302 is displayed in inspection, assembly, or the like of an industrial device. Since the image display region 111 is limited, when the work procedure specification 301 and the drawing 302 are simultaneously displayed, contents are reduced, and thus visibility deteriorates. Therefore, head tracking in which a direction of the head of the user 2 is detected by an acceleration sensor is performed, and a display content is changed in correspondence with the direction of the head to improve the visibility. That is, in FIG. 10, the work procedure specification 301 is displayed in the image display region 111 in a state in which the user 2 faces the left, and when the user faces the right, the drawing 302 is displayed in the image display region 111. Accordingly, display can be performed as if a virtual image display region 112 capable of visually recognizing the work procedure specification 301 and the drawing 302 in a wide visual field exists.

According to this, the visibility is improved, and the user 2 can perform a work while simultaneously visually recognizing a work target (a device, a tool, or the like) and a work instruction, and thus the work can be performed in a more reliable manner, and thus a mistake can be reduced.

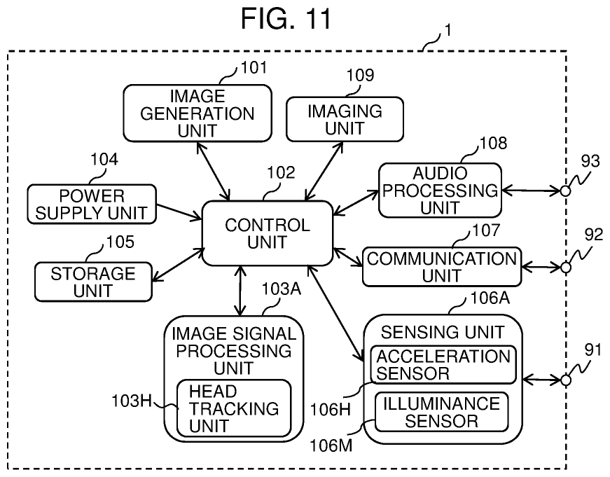

FIG. 11 is a functional block configuration diagram of the HMD in this example. In FIG. 11, the same reference numeral will be given to the same configuration as in FIG. 1, and description thereof will be omitted. FIG. 11 is different from FIG. 1 particularly in that a head tracking function is added. That is, a head tracking unit 103H is provided in an image signal processing unit 103A of the HMD 10. The head tracking unit 103H detects a direction of the head of the user 2 on the basis of information obtained by an acceleration sensor 106H in a sensing unit 106A, and changes a display content in correspondence with the direction of the head.

In addition, the HMD is used indoors. Accordingly, it is necessary to adjust luminance of a display image in correspondence with the brightness of an ambient environment. As an example, an illuminance sensor 106M is mounted in the sensing unit 106A, and luminance of an image that is displayed by the image signal processing unit 103A may be adjusted in correspondence with an output of the illuminance sensor 106M.

Hereinbefore, although the examples have been described, the invention can reduce the amount of materials which are used by realizing a reduction in size of an optical system while realizing high image quality of a display image of an image projection device. Accordingly, carbon emission is reduced and global warming is prevented, and the invention particularly contributes to energy of Item 7 for realizing sustainable development goals (SDGs).

In addition, the invention is not limited to the above-described examples, and includes various modification examples. For example, the functional configuration of the HMD and the image generation unit 101 are classified in correspondence with main processing contents for easy comprehension. The invention is not limited by a classification method or the name of constituent elements. The configuration of the HMD and the image generation unit 101 can also be classified into a large number of constituent elements in correspondence with processing contents. In addition, classification can be made so that one constituent element executes more processes.

In addition, it is not needless to say that the invention is applicable to not only the HMD but also other image (virtual image) display devices having the configuration of the image generation unit 101 described in each example in a similar manner.

In addition, a part of the configuration in an example can be substituted with other a configuration of another example. In addition, a configuration of another example can also be added to a configuration of an example. In addition, addition, deletion, or substitution of another configuration to a part of the configuration in each example is also possible.

What is claimed is:

1. An illumination optical unit configured to illuminate an image display unit configured to display an image, comprising:
a light source configured to emit light;
a lens unit configured to convert divergent light from the light source into approximately collimated light; and
a light branching unit to which the light emitted from the lens unit is incident, and which branches an optical path into an optical path of illumination light propagating to the image display unit, and an optical path along which light from the image display unit propagates to a projection side,
wherein the light branching unit includes two or more emission/reflection planes configured to emit the illumination light.

2. The illumination optical unit according to claim 1,
wherein the light branching unit has a set of approximately parallel main surfaces which confine the illumination light through internal reflection, and
an interval between the two or more emission/reflection planes is smaller than a length of a predetermined one side of the image display unit.

3. The illumination optical unit according to claim 1,
wherein the light branching unit has a set of approximately parallel main surfaces which confine the illumination light through internal reflection,
a reflection film formed on the emission/reflection planes is a polarizing reflection film, and
a polarization filter is disposed between the light branching unit and the projection unit.

4. The illumination optical unit according to claim 1,
wherein the emission/reflection planes are partial reflection planes which partially reflect light, and
a reflectance of the two or more emission/reflection planes is higher as being farther from an incident part of the light branching unit.

5. The illumination optical unit according to claim 1,
wherein the light branching unit and the image display unit are disposed with an interval of 1 mm or greater.

6. The illumination optical unit according to claim 1,
wherein an arrangement direction of the two or more emission/reflection planes of the light branching unit and a short-side direction of an effective region in the image display unit is approximately parallel to each other.

7. The illumination optical unit according to claim 1, further comprising:
a light integrator to which light from the light source is incident and which emits the light to the lens unit,
wherein the light integrator has a shape similar to a quadrangular column or a circular column, and the inside is filled with a medium A having predetermined high transparency, and is filled with scattering particles formed from a highly transparent medium B having a refractive index different from a refractive index of the medium A.

8. The illumination optical unit according to claim 1, further comprising:
a light integrator to which light from the light source is incident and which emits the light to the lens unit,
wherein the light integrator is divided into a layer that has a shape similar to a quadrangular column or a circular column and the inside is filled with a medium A having predetermined high transparency, and a layer filled with scattering particles formed from a highly transparent medium B having a refractive index different from a refractive index of the medium A.

9. The illumination optical unit according to claim 1, further comprising:
a luminance uniformizing unit disposed between the light branching unit and the lens unit.

10. The illumination optical unit according to claim 1, further comprising:
a light integrator to which light from the light source is incident and which emits the light to the lens unit,
wherein the light integrator has a shape similar to a quadrangular column or a circular column, and the inside is filled with a medium A having predetermined high transparency, and
a diffusion plate as a luminance uniformizing unit is provided between the light branching unit and the lens unit.

11. An image projection device configured to project an image, comprising:
an image display unit configured to display an image;
an illumination optical unit configured to illuminate the image display unit; and
a projection unit configured to enlarge image light of the image display unit and project the image light as a virtual image,
wherein the illumination optical unit includes,
a light source configured to emit light,
a light integrator to which light from the light source is incident, the inside being filled with a medium having predetermined high transparency and scattering particles, and
a lens unit configured to convert divergent light from the light integrator into approximately collimated light, and
a luminance uniformizing unit is provided between the image display unit and the lens unit.

12. The image projection device according to claim 11, wherein the image display unit is constituted by a transmission type liquid crystal panel.

13. The image projection device according to claim 11, further comprising:
a light branching unit to which the light emitted from the lens unit is incident, and which branches an optical path into an optical path of illumination light propagating to the image display unit, and an optical path along which light from the image display unit propagates to a projection side,
wherein the light branching unit has a set of approximately parallel main surfaces which confine the illumination light with internal reflection, and two or more emission/reflection planes from which the illumination light is emitted, and
a polarization filter is disposed between the light branching unit and the projection unit.

14. The image projection device according to claim 11, further comprising:
a light guide unit configured to duplicate image light transmitted from the projection unit and transfer the image light to user's pupil,
wherein the light guide unit has two or more emission/reflection planes which are partial reflection planes, and functions as a head-mounted display that displays an image within a visual field of a user.

15. The image projection device according to claim 11, further comprising:
a power supply unit configured to supply power;
a sensing unit configured to detect a position or a posture of a user;
an audio processing unit configured to perform input or output of an audio signal; and
a control unit configured to perform control of the power supply unit, the sensing unit, and the audio processing unit.
